(19) United States
(12) Patent Application Publication
(10) Pub. No.: US 2026/0140096 A1
(43) Pub. Date: May 21, 2026

(54) Thermal Conductivity Detector (TCD) Based Gas Chromatography (GC) Device

(71) Applicant: ABB Schweiz AG, Baden (CH)

(72) Inventors: Subhashish Dasgupta, Bangalore (IN); Steve Hardy, Bixby, OK (US); Yannick Maret, Baden-Dättwil (CH)

(73) Assignee: ABB Schweiz AG, Baden (CH)

(21) Appl. No.: 19/416,468

(22) Filed: Dec. 11, 2025

Related U.S. Application Data
(63) Continuation of application No. PCT/IB2024/054971, filed on May 22, 2024.

(30) Foreign Application Priority Data
Jun. 12, 2023 (IN) 202341040094

(51) Int. Cl. G01N 30/66; G01N 30/02

(52) U.S. Cl. CPC G01N 30/66; G01N 2030/025

(57) ABSTRACT

A Thermal Conductivity Detector (TCD) based Gas Chromatography (GC) device includes a TCD oven formed by a plurality of walls and has an inlet valve and an one outlet valve; a TCD element housed in the TCD oven; a heating source mounted on any one of the plurality of walls of the TCD oven; a Thermoelectric Generator (TEG) thermally connected to the TCD element; and a detector circuit configured to: determine thermal gradient in mixture gas, wherein the mixture gas is mixture gas of carrier gas and analyte gas fed to TCD oven; and generate electrical signal based on thermal gradient.

### CROSS-REFERENCE TO RELATED APPLICATIONS

The instant application claims priority to International Patent Application No. PCT/IB2024/054971, filed May 22, 2024, and to Indian Patent Application No. 202341040094, filed Jun. 12, 2023, each of which is incorporated herein in its entirety by reference.

### FIELD OF THE DISCLOSURE

The present disclosure generally relates to a Thermal Conductivity Detectors (TCD) based Gas Chromatography (GC) and more particularly to a TCD based Gas Chromatography (GC) device having a Thermoelectric Generator (TEG).

### BACKGROUND OF THE INVENTION

Gas Chromatography (GC) is a technique that involves analytical separation and detection of components of a sample gas which is a mixture of gases. A conventional system for GC utilizes a Thermal Conductivity Detector (TCD). The TCD is a detector that works on the principle of heat transfer by convection, where the TCD responds to the difference in thermal conductivity of the carrier gas and the carrier gas containing a sample gas. There exists wide range of TCD's with different configurations used for GC/gas analysis of the sample gas.

The existing GC system uses the TCD to output an electrical signal corresponding to the concentrations of the sample gas mixed with carrier gas. The electrical signal is then given to a chromatographic computational unit to determine the concentrations of the sample/analyte gas. The electrical signal from the TCD is a chromatogram signal comprising corresponding concentrations of compounds present in the sample gas. In order to increase the measurement accuracy and minimize the impact of noise sources in the GC, it is required to increase the heat of the heating element and decrease the heat of the heating source of any one of the plurality of walls of the TCD oven, thereby increasing the magnitude of the electrical signal of the TCD. However, the heating element inside the TCD oven has a temperature limit and increasing the temperature beyond the limit can permanently damage the heating element. Further, the heating source mounted on any one of the plurality of walls of the TCD oven has a certain limit to decrease the temperature, and if the temperature is decreased more than the limit it could lead to condensation of the air moisture in the TCD oven, which could lead to unfavorable conditions. Due the constrains it is not possible to increase the magnitude of the electrical signal without damaging the bead or reaching condensation point in the TCD oven. Therefore, to overcome the shortcomings of the conventional GC system there is a need for development of an advanced and efficient system for GC with capability to increase the magnitude of electrical signal, thereby increasing the measurement accuracy.

The information disclosed in this background of the disclosure section is only for enhancement of understanding of the general background of the invention and should not be taken as an acknowledgement or any form of suggestion that this information forms the prior art already known to a person skilled in the art.

### BRIEF SUMMARY OF THE INVENTION

Disclosed herein is a Thermal Conductivity Detector (TCD) based Gas Chromatography (GC) device operating and a Thermal Conductivity Detector (TCD) based Gas Chromatography (GC) device operating under constant temperature. The TCD based GC device, comprises: a TCD oven formed by a plurality of walls, wherein the TCD oven comprises an inlet valve and an outlet valve; a TCD element housed within the TCD oven; a heating source mounted on any one of plurality of walls of the TCD oven; a Thermoelectric Generator (TEG) thermally connected to the TCD Element; and a detector circuit connected to the TCD element.

The TCD based GC device operating under content temperature, comprises; a TCD oven formed by a plurality of walls, the TCD oven comprises an inlet valve and an outlet valve; a TCD element housed within the TCD oven; a heating source mounted on any one of plurality of walls of the TCD oven; a Thermoelectric Generator (TEG) thermally connected to the TCD Element; at least one temperature sensor thermally connected to the TEG; and a detector circuit connected to the TCD element.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE SEVERAL VIEWS OF THE DRAWING(S)

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of the system and/or methods in accordance with embodiments of the present subject matter are now described, by way of example only, and regarding the accompanying figures, in which:

FIG. 1 illustrates a Thermal Conductivity Detector (TCD) based Gass Chromatography (GC) device, in accordance with some embodiments of the present disclosure.

FIG. 2 illustrates an alternative embodiment of Thermal Conductivity Detector (TCD) based Gass Chromatography (GC) device, in accordance with some embodiments of the present disclosure.

FIG. 3 illustrates a configuration of a detector circuit, in accordance with some embodiments of the present disclosure.

FIG. 4 illustrates a graph of reverse thermal gradient determined within the TCD oven (102, 202), in accordance with some embodiments of the present disclosure.

FIG. 5 is a graph that illustrates an electrical signal of the TCD based GC device (100, 200), in accordance with some embodiments of the present disclosure.

FIG. 6 illustrates simulation results of TCD based GC device (100, 200), in accordance with some embodiments of the present disclosure. It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION OF THE INVENTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

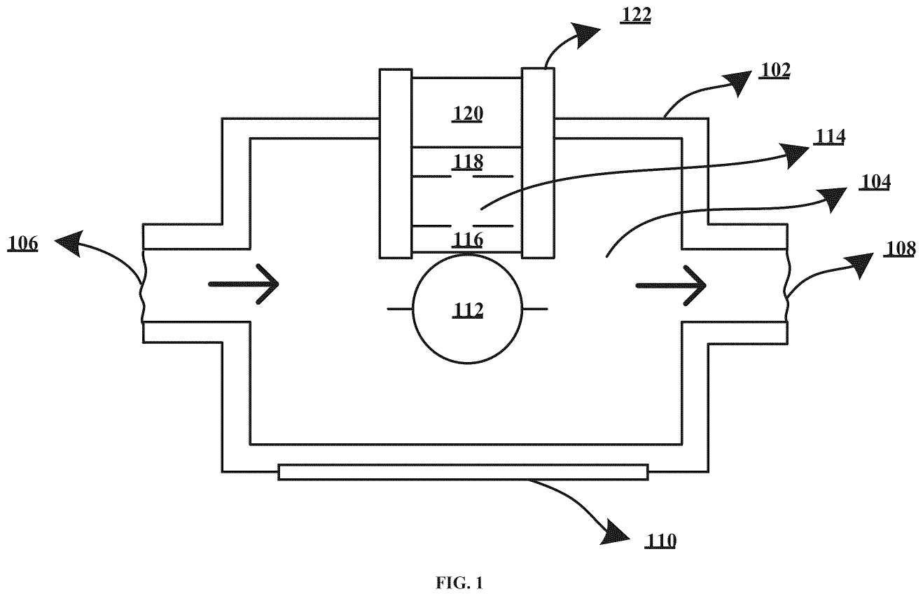

FIG. 1 illustrates a Thermal Conductivity Detector (TCD) based Gas Chromatography (GC) device (100), in accordance with some embodiments of the present disclosure.

In an embodiment, the TCD based GC device (100) as illustrated in FIG. 1 comprises a TCD oven (102) formed by a plurality of walls. The TCD oven (102) comprises an inlet valve (106) and an outlet valve (108), a TCD element (112) housed within the TCD oven (102). The TCD based GC device (100 further comprises a heating source (110) mounted on any one of the plurality of walls of the TCD oven (102), a Thermoelectric Generator (TEG) (114) thermally connected to the TCD element (112); and a detector circuit connected to the TCD element (112).

In an embodiment, a cavity (104) is, without limitation, a space defined inside the TCD oven (102), by the plurality of walls. The cavity (104) is capable of receiving at least one of a carrier gas and a sample gas. The carrier gas is an inert gas that carries the sample gas and the properties of carrier gas are known. Whereas the sample gas is an analyte gas for which the concentration level is to be determined by determining its thermal conductivity. In an embodiment, the carrier gas is, without limitation, nitrogen (N) gas, helium (He) gas, hydrogen (H) gas, argon (Ar) gas, and carbon dioxide (CO₂) gas.

In an embodiment, a temperature T₀ of the TCD element (112), without limitation, can range from 20 degree Celsius up to 25 degrees Celsius, under normal working conditions. In an embodiment, a temperature T_{w} of interior side of the plurality of walls of the TCD oven (102) can range, without limitation, from 60 degree Celsius up to 70 degree Celsius, under normal working conditions. In an embodiment, a temperature T_{fs} of the TEG (114) can, without limitation, range from 15 degree Celsius to 20 degrees Celsius under normal working condition.

In an embodiment, the heating source (110), mounted on the interior side of any one of plurality of walls of the TCD oven (102) of TCD based GC device (100), is heated such that temperature of plurality of walls (inner side of the walls) of the TCD oven (102) reaches a predefined temperature T_{w}. This essentially heats a portion of the cavity (104) in the proximity of the plurality of the walls to the temperature T_{w}. After the temperature of the portion of the cavity (104) has reached T_{w}, the carrier gas of known properties is introduced to the cavity (104) via the inlet valve (106) of the TCD oven (102). The carrier gas can have, without limitation, a high thermal conductivity, which creates a steady thermal state in the cavity (104) within the TCD oven (102). Further, the TEG (114) is operated using an electronic control circuit (not shown in FIG. 1) to reduce the temperature of the TCD element (112) such that the temperature of the TCD element (112) is maintained at the predefined temperature T₀. The temperature T₀ is less than the temperature of surrounding walls i.e., temperature T_{w}. Once the temperature of TCD element (112) and the temperature of the plurality of walls reaches their respective predefined temperature T₀ and T_{w}, the analyte gas of unknown properties is introduced into the cavity (104) of the TCD oven (102).

In an embodiment, the detector circuit is used to determine a thermal gradient in a mixture gas, where the mixture gas is the mixture of the carrier gas and the analyte gas fed to the TCD oven (102), and generate an electrical signal based on the thermal gradient.

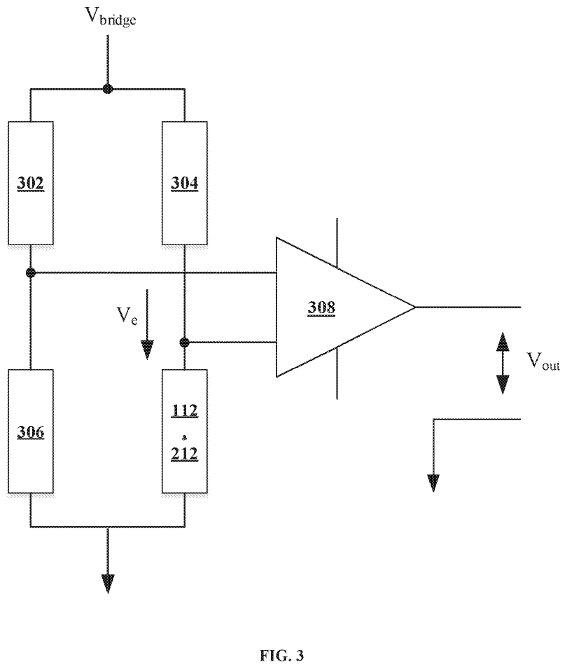

In an embodiment, the TCD element (112) is a heating element connected in the detector circuit. In an embodiment, the detector circuit is, without limitation, a bridge circuit (as shown in FIG. 3). Current circulating in the bridge circuit operates/heats the TCD element (112). The TCD element (112), without limitations, is connected in a Wheatstone bridge configuration along with three resistors with known resistance rating, such that the differential current developed in the bridge circuit is the manifested electrical signal proportional to the concentrations of the analyte gas.

In an embodiment, the TEG (114), without limitations, is a cooling unit comprising a first side (116), a second side (118) and an extended conductive path (120). The first side (116) of the TEG (114) is cooler compared to the second side (118) of the TEG (114). The extended conductive path (120) extends from the second side (118) of the TEG (114) away from the center of the TCD oven (102). To provide more clarity the conductive path (120) extended towards a surrounding environment to dissipate the heat extracted from the TCD element (112). In an alternative embodiment, the extended conductive path (120) of the TEG (114) can be, without limitations, is at least one of a conductive path that extends from the second side (116) of the TEG (114), away from a center of the TCD oven (102)

In an embodiment, the TCD based GC device (100) comprises the TCD oven (102) having the inlet valve (106) and the outlet valve (108). The TCD based GC device (100) along with its mechanical configurations also comprises the detector circuit, that outputs a differential current flowing in the circuit. The detector circuit, without limitation, can be a Wheatstone bridge circuit that operates on the principle of zero differential current. Under imbalance conditions the Wheatstone bridge circuit outputs a differential current due to change in the resistances of the components connected in the circuit. Therefore, due to the influence of the mixture of the carrier gas and the analyte gas on the TCD element (112), the temperature of the TCD element (112) changes thereby changing the resistance of the TCD element (112). Thus, the change is resistances of the TCD element (112) manifests a differential current in the electronic circuit, which is then fed to an amplifier connected to the detector circuit. In an embodiment, the manifested differential current is electrical signal proportional to the concentration of the sample gas introduced to the cavity (104) of the TCD oven (102).

In an embodiment, the output of the amplifier connected to the detector circuit is fed to an external computational unit/computer unit (not shown) for analyzing purpose. Thereby analyzing the proportional/concentrations of the analyte gas.

In an embodiment, the TCD oven (102) is provided with a thermal isolation membrane (122). The thermal isolation membrane (122) thermally isolates the TEG (114) and the thermal conductive path (120) of the TEG (114) from the cavity (104) of the TCD oven (102) i.e., from the heat of the plurality walls of the TCD oven (102). The thermal isolation membrane (122) is provided such that the TEG (114) only extracts heat from the TCD element (112) and not from the other parts of the TCD oven (102).

In an embodiment, thermal flux flowing through the TEG (114) may be determined using the temperature T₀, the electrical power used to operate the TEG (114) to maintain the temperature of the TCD element (112) at T₀ and efficiency of the TEG (114). The thermal conductivity of the gas is proportional to the thermal flux.

In an embodiment, to determine the relative thermal conductivity of the second side (118) of the TEG (114), parameters such has TEG (114) efficiency, T_{w} [symbol] and T₀ [symbol] are considered as constants. The two temperature setpoints of T_{w} then act as tuning parameter that influence sensitivity of the TCD.

In an embodiment, the thermal flux flowing through the TEG (114) may be determined using temperature T₀, electrical power consumed by the TEG (114) to maintain the temperature of the TCD element (112) at T₀ and efficiency of the TEG (114). The thermal conductivity of the mixture gas directly/indirectly influences the temperature of the TCD element (112). Therefore, the electrical power consumed by the TEG (114) to maintain the temperature of the TCD element (112) at T₀ and the efficiency of the TEG (114) is directly proportional to the thermal flux flowing through the TEG (114). In other words, the thermal conductivity of the mixture gas is proportional to the thermal flux flowing in the TEG (114). Further, to determine the relative thermal conductivity of the second side (116) of the TEG (114), parameters such has TEG (114) efficiency, T_{w} [symbol] and T₀ [symbol] are considered as constants. When TEG (114) efficiency, T_{w} [symbol] and T₀ [symbol] are considered as constants, the two temperature setpoints of T_{w} act as tuning parameters that influence the sensitivity of the TCD.

In an embodiment, a thermal gradient in the GC (100) is a difference between the temperature measured near the TCD element (112) and the temperature measured near any one of the plurality of walls of the TCD oven (102). The strength of the electrical signal manifested in the detector circuit, i.e., the strength of the differential current is directly proportional to the thermal gradient determined by the detector circuit. In an embodiment, the strength of the manifested electrical signal is increased by increasing the thermal gradient. Increasing the thermal gradient comprises increasing, by the TD based GC device (100), the temperature/heat of the plurality walls interior side, by controlling the heating source (110) mounted on any one of plurality of walls of the TCD oven (102). Further, the TCD based GC device (100) decreases the temperature of the TCD element (112) by operating the TEG (114) to extract the heat from the TCD element (112). Thus, the process of decreasing the temperature of TCD element (112) and increasing the temperature of plurality of walls of the TCD oven (102) produces a high magnitude reverse thermal gradient, thereby increasing the strength of the manifested electrical signal.

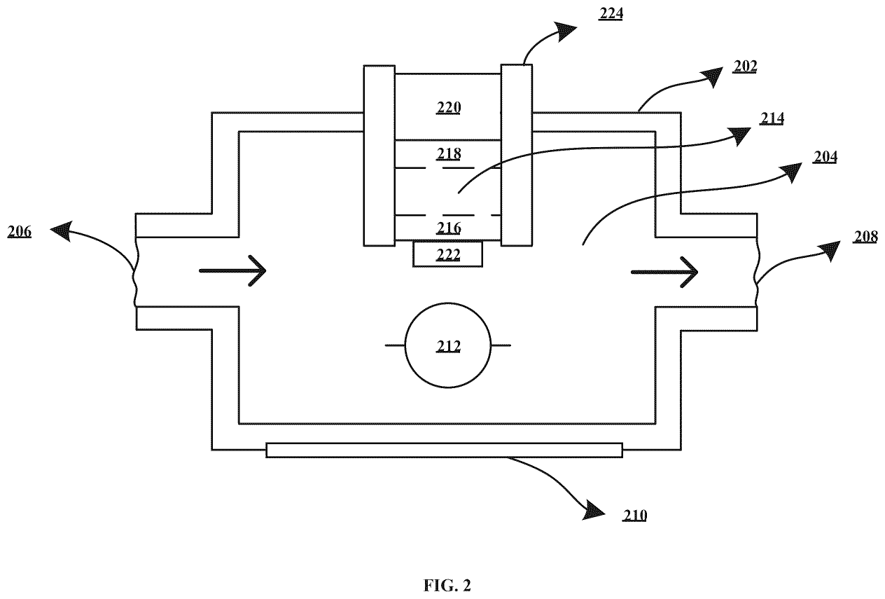

FIG. 2 illustrates an alternative embodiment of Thermal Conductivity Detector (TCD) based Gass Chromatography (GC) device (200), in accordance with some embodiments of the present disclosure.

FIG. 2 illustrates an alternative embodiment for analyzing the analyte gas using TCD based GC device. In an embodiment, the TCD based GC device (200) comprises a TCD oven (202) formed by one or more of walls. The TCD oven (202) comprises an inlet valve (206) and an outlet valve (208). A TCD element (212) is housed within the TCD oven (202). A heating source (210) is mounted on any one of plurality of walls of the TCD oven (202). A Thermoelectric Generator (TEG) (214) is thermally connected to the TCD Element (212). At least one temperature sensor (222) is thermally connected to the TEG (214). Finally, a detector circuit is connected to the TCD element (212).

This alternative embodiment of the TCD based GC device (200) discloses an additional feature which is different and unique from that the previous embodiment of the claimed invention as disclosed in FIG. 1.

In the same embodiment, the TCD based GC device (200) comprises one structural feature which is unique compared to the TCD based GC device (100). The structural feature being, the temperature sensor (222) is thermally connected to the first side (216) of the TEG (214), whereas in TCD based GC device (100) the TCD element (112) was thermally connected to the first side (116) of the TEG (114). TCD element (112) in the TCD based GC device (100), is arranged such that there exists both physical and thermal conductive connection between the first side (116) of the TEG (114) and the TCD element (112). But the TCD element (212) in the TCD based GC device (200), is arranged proximate to the first side (216) of the TEG (214) having a predefined distance in between the first side (216) and TCD element (212). The temperature sensor (222) is arranged in the gap and thermally connected to the first side (216) of the TEG (214) for measuring the temperature of the first side (216) of the TEG (214). In an embodiment, the predefined distance between the first side (216) of the TEG (214) could be, without limitation, in nanometers, millimeters, centimeters, meters etc. The predefined distance also depends on type and size of the temperature sensor (222) used in the TCD based GC device (200).

In the same embodiment, the heating source (210) mounted on any one of the plurality of walls of the TCD oven (202), is operated to achieve a predefined temperature T_{w} at the plurality of walls. Further, the analyte gas followed by the carrier gas is introduced into the cavity (204) of the TCD oven (202).

In an embodiment, the TEG (214) is operated to maintain the temperature of the temperature sensor (222) at the predefined temperature T₀. Further, the mixture of the carrier gas and the analyte gas within the cavity (204) of the TCD oven (202) directly/indirectly influences the temperature of the TCD element (212). Since temperature of the TCD element (212) is directly proportional to resistance of the TCD element (212), the change in temperature of the TCD element (212) changes the resistance of the TCD element (212). The change in resistance of the TCD element (214) thereby causes resistance imbalance between the components of the detector circuit. The imbalance in the resistance of the components in the detector circuit manifests the differential current to flow in the circuit.

In an embodiment, the at least one temperature sensor (222) and the electronic control circuit of the TEG (214) are cooperatively operated to control the TEG (214) such that the TEG (214) maintains the temperature of the temperature sensor (222) at the predefined temperature T₀. In an embodiment, the change in temperature at the first side (216) of the TEG (214) at the first side (216) of the TEG (214), is measured by the at least one temperature sensor (222) which thermally coupled to the first side (216) of the TEG (214). The at least one temperature sensor (222) outputs an electrical signal corresponding to the change in temperature at the first side (216) of the TEG (214). In an embodiment, the electrical signal produced by the at least one temperature sensor (222) is proportional to the concentration of the analyte gas.

In an embodiment, the electrical signal produced by the at least one temperature sensor (222) is fed to the external computational unit/computer unit for analysis. The electrical signal is used fora analyzing the concertation of the analyte gas using chromatography technique, using the electrical signal produced by the at least one temperature sensor (222).

In an embodiment, a thermal gradient is a difference between the temperature sensed in the proximity of the TCD element (212) and the temperature sensed in the proximity of any one of plurality of walls of the TCD oven (202). The strength of the electrical signal manifested in the electronic control circuit of the TEG (214) i.e., the strength of the electrical signal produced by the at least one temperature sensor (222) is directly proportional to the thermal gradient determined by the electronic control circuit of the TEG (214). In an embodiment, the strength of the manifested electrical signal is increased by increasing the thermal gradient. Increasing the thermal gradient comprises controlled by the TCD based GC device (200), the heating source (210) mounted on any one of the plurality of walls of the TCD oven (202). Further, decreasing the temperature of the TCD element (212) using the TEG (214) to extract the heat from the TCD element (212). Since the thermal gradient is determined by taking the difference between the temperature proximate to the TCD element (212) and the temperature proximate to any one of plurality of walls of the TCD oven (202). Therefore, the process of decreasing the temperature of TCD element (212) and increasing the temperature of plurality of walls of the TCD oven (202) produces a reverse thermal gradient signal. Thus, higher the magnitude of the reverse thermal gradient signal, higher is the strength of the manifested electrical signal.

This alternative embodiment of the TCD based GC device does not require more parameters to determine the thermal conductivity of the analyte gas, such as T₀, T_{w}, thermal flux flowing through the TEG (114), or TEG (114) assembly efficiency. Whereas the first embodiment of the TCD based GC device (100) is dependent on these parameters to determine the thermal conductivity of the analyte gas.

The alternative embodiment of the TCD based GC Device (200) provides robust measurements for analyzing the concentrations of the analyte gas.

FIG. 3 illustrates the configuration of a detector circuit, in accordance with some embodiments of the present disclosure.

In an embodiment, the TCD element (112 and 212) is mechanically arranged in the TCD oven (102 and 202) and electrically connected in the Wheatstone configuration bridge circuit referred as the detector circuit (300) in the present disclosure and as illustrated in FIG. 3. The detector circuit (300) comprises four components connected in the Wheatstone bridge configuration such that during imbalance condition the detector circuit (300) outputs the differential current. Among the four components of the bridge circuit one component is the TCD element (112, 212) of unknown resistance rating and remaining three (302, 304, 306) components are resistors of known resistance ratings. The detector circuit (300) is an electronic circuit which is operated by supplying electric power to input terminals of the detector circuit (300). The four components of the detector circuit also form two bridges among which the differential current gets manifested. During normal working condition constant voltage is applied to the input terminals of the detector circuit (300) and the resistances of all four components including the TCD element (112, 212) are equal and therefore no differential current flows in the circuit. An amplifier (308) is additionally connected to the detector bridge circuit to amplify the differential signal manifested in the circuit.

In an embodiment, when the thermal conductivity property of the mixture gas influences the temperature of the TCD element (112 and 212) connected in detector circuit (300), the temperature of the TCD element (112 and 212) increases/decreases thereby increasing/decreasing the resistances of the TCD element (112, 212). This increase/decrease of the resistance of the TCD element (112 and 212) causes imbalance of resistance with respect to other three components (302, 304 and 306) connected in the detector circuit (300). Therefore, the imbalance in resistances causes the differential current to manifest in the detector circuit (300) which is then fed to an external computational unit/computer unit for analysis. The differential current is the manifested electrical signal in the detector circuit (300) which is proportional to the concentrations of the analyte gas. Therefore analyzing the manifested electrical signal will give the exact concentrations of the analyte gas. In an embodiment, the manifested electrical signal is, without limitation, a chromatogram signal.

In an alternative embodiment, the output of the detector circuit (300) can be, without limitation, fed to the input terminals of the TEG (114 and 214) to regulate the heat extraction from the TCD element (112 and 212) based on the electrical signal manifested, such that the supply to the TEG (114 and 214) becomes a constant.

In an embodiment, when all four components in the detector circuit (300) is of same resistance, the differential voltage Vₑ is zero. Under such conditions, there are two ways to operate the detector circuit (300).

In an embodiment, the first approach is by injecting constant voltage to the detector circuit (300), in this case the output of the amplifier (308) Vₒᵤₜ is proportional to differential voltage Vₑ. The thermal flux flowing through the TEG (114) may be determined using temperature T₀, electrical power used to operate the TEG (114) to maintain the temperature of the TCD element (112) at T₀ and efficiency of the TEG (114). The thermal conductivity of the mixture directly/indirectly influences the temperature of the TCD element (112). Therefore the electrical power consumed by the TEG (114) to maintain the temperature of the TCD element (112) at T₀ and the efficiency of the TEG (114) is directly proportional to the thermal flux flowing through the TEG (114). In other words, it can be said that the thermal conductivity of the mixture gas is proportional to the thermal flux flowing in the TEG (114). Further, to determine the relative thermal conductivity of the second side (118) of the TEG (114), parameters such has TEG (114) efficiency, T_{w} [symbol] and T₀ [symbol] are considered as constants. When TEG (114) efficiency, T_{w} [symbol] and T₀ [symbol] are considered as constants the two temperature setpoints of T_{w} acts as tuning parameter that influences the sensitivity of the TCD.

In an embodiment, second approach is operating the detector circuit (300) at a constant temperature. Here, the amplifier (308) output Vₒᵤₜ controls V_{bridge} to ensure that the temperature of TCD elements (112 and 212) is exactly equal to the predefined temperature T₀. In an embodiment, the at least one temperature sensor (222) and the electronic control circuit of the TEG (214) is cooperatively operated to control the TEG (214) such that the TEG (214) maintains the temperature of the TCD element (212) at the predefined temperature T₀. In an embodiment, the change in temperature at the first side (216) of the TEG (214) i.e., increase/decrease in temperature at the first side (216) of the TEG (214), is measured by the at least one temperature sensor (222) thermally connected to the first side (216) of the TEG (214). The at least one temperature sensor (222) outputs an electrical signal corresponding to the change in temperature at the first side (216) of the TEG (214). In an embodiment, the electrical signal produced by the at least one temperature sensor (222) is proportional to the concentration of the analyte gas.

In an embodiment, the electrical signal produced by the at least one temperature sensor (222) cooperatively connected to the electronic control circuit, can be, without limitation, fed to the external computational unit/computer unit for analysis, thereby analyzing the concertation of the analyte gas using chromatography technique, using the electrical signal produced by the at least one temperature sensor (222).

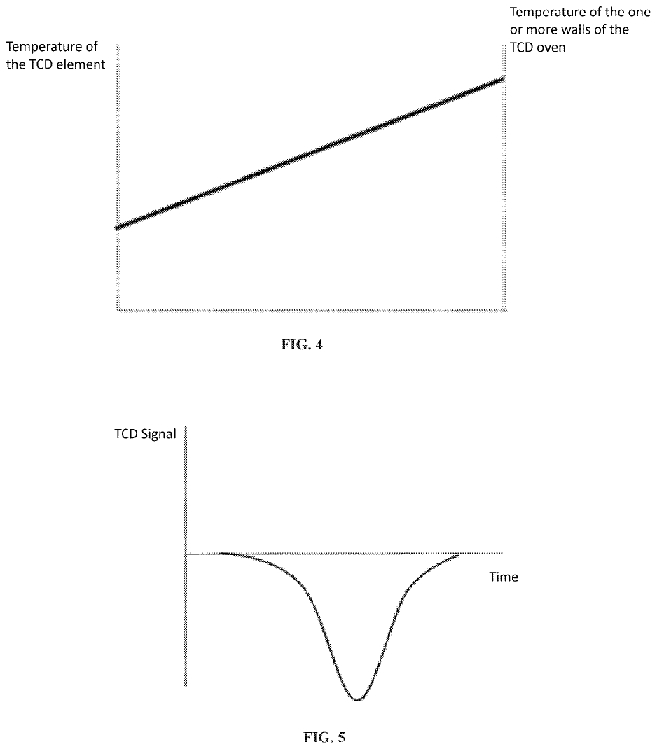

FIG. 4 illustrates a graph of reverse thermal gradient determined within the TCD oven (102, 202), in accordance with some embodiments of the present disclosure.

In an embodiment, the thermal gradient is increased by increasing the temperature of the plurality of walls of the TCD oven (102, 202) and decreasing the temperature of the TCD element (112, 212). This process manifests the reverse thermal gradient signal as illustrated in FIG. 4.

FIG. 5 is a graph that illustrates an electrical signal of the TCD based GC device (100, 200), in accordance with some embodiments of the present disclosure.

In an embodiment, the electrical signal manifested in the detector circuit (300) i.e., the differential current flowing in the detector circuit (300), is as illustrated in FIG. 5. The electrical signal is directly proportional to the magnitude of the thermal gradient.

In an embodiment, increasing the magnitude of the electrical signal comprises: controlling the TEG (114, 214) to extract the heat of the TCD element (112, 212) and controlling the heating source (110, 210) mounted on any one or one or more walls, to increase the heat of the one or more of walls of the TCD oven (102, 202). Therefore decreasing the heat of the TCD element (112, 212) and increasing the heat of the one or more of walls thereby directly increases the magnitude of the thermal gradient in the mixture and indirectly increases the strength of the electrical signal thereby increasing the accuracy of the gas analysis.

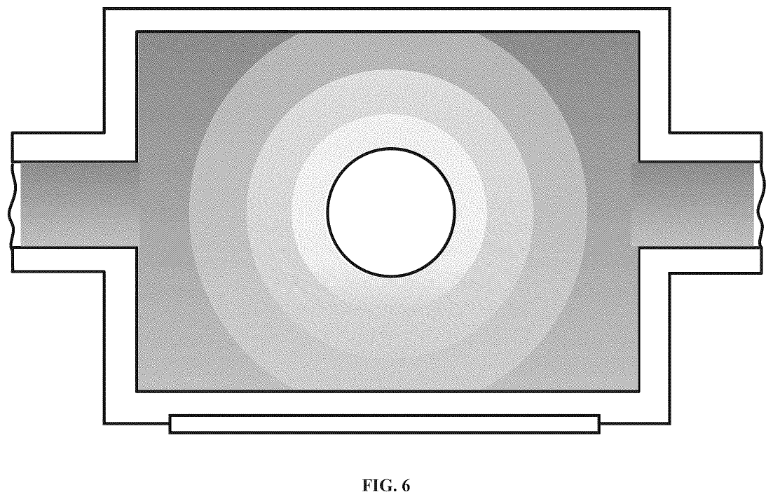

FIG. 6 illustrates thermal simulation results of TCD based GC device (100, 200) in practical implementation, in accordance with some embodiments of the present disclosure.

In an embodiment, FIG. 6 illustrates the simulation results of the TCD based GC device (100, 200) in practical implementation for analysis of the analyte gas. In an embodiment, dash lines within the cavity (104, 204) of the TCD oven (102, 202) depicts the different distance from the TCD element (112, 212) having slightly different temperature value due to different temperature value at the TCD element (112, 212) i.e., T₀ and the temperature values at the plurality of walls of the TCD oven T_{w}.

In an embodiment, the detector circuit (300) of the TCD based GC device (100, 200) determines the thermal gradient of the mixture gas i.e., mixture of the carrier gas and the analyte gas. The detector circuit (300) determines the thermal gradient using the temperature value proximate to the TCD element (112, 212) and the temperature value proximate to the any one of plurality of walls of the TCD oven (102, 202).

In an embodiment, the present disclosure provides a Thermal Conductivity Detector (TCD) based Gas Chromatography (GC) device (100, 200) that provides an ability to increase the accuracy of GC analysis. I.e., the TCD based GC device (100, 200) provides a provision to increase the thermal gradient within the TCD oven (102, 202) and thereby increasing thermal gradient indirectly increases the magnitude of the electrical signal and indirectly increases the accuracy of the TCD based GC device (100, 200).

As stated above, it shall be noted that the method of the present disclosure may be used to overcome various technical problems related to Gas Chromatography (GC). In other words, the disclosed TCD based GC device (100, 200) has a practical application and provides a technically advanced solution to the technical problems associated with the existing approach for analysis of the analyte gas i.e., Gas Chromatography (GC).

In light of the technical advancements provided by the disclosed method, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Referral Numerals

| Reference Number | Description |
|---|---|
| 100 | Thermal Conductivity Detectors (TCD) based |
| | Gass Chromatography (GC) device. |
| 102, 202 | TCD oven |
| 104, 204 | Cavity of the TCD oven. |
| 106, 206 | Inlet valve of the TCD oven. |
| 108, 208 | Outlet valve of the TCD oven. |
| 110, 210 | Heating source |
| 112, 212 | TCD element |
| 114, 214 | Thermoelectric Generator (TEG) |
| 116, 216 | First side of the TEG |
| 118, 218 | Second side of the TEG |
| 120, 220 | Extended conductive path of the TEG |
| 222 | Temperature sensor |
| 122, 224 | Thermal isolation membrane |
| 302 | Resistor 1 |
| 304 | Resistor 2 |
| 306 | Resistor 3 |
| 308 | Amplifier |

What is claimed is:

1. A Thermal Conductivity Detector (TCD) based Gas Chromatography (GC) device (100), comprising:
a TCD oven formed by a plurality of walls, wherein the TCD oven comprises at least one inlet valve and one outlet valve;
a TCD element housed in the TCD oven;
a heating source mounted on any one of the plurality of walls of the TCD oven;
a Thermoelectric Generator (TEG) thermally connected to the TCD element; and
a detector circuit connected to the TCD element.

2. The TCD based GC device as claimed in claim 1, wherein the TCD oven is a cavity arranged to receive at least carrier gas and analyte gas.

3. The TCD based GC device as claimed in claim 1, wherein the TCD element is operated by the detector circuit.

4. The TCD based GC device as claimed in claim 1, wherein the TEG is a cooling unit comprising a first side, a second side and an extended conductive path.

5. The TCD based GC device as claimed in claim 4, wherein the first side of the TEG is cooler compared to the second side of the TEG, wherein the first side of the TEG is thermally connected to the TCD element.

6. The TCD based GC device as claimed in claim 4, wherein the extended conductive path is at least one of a conductive path that extends from the second side of the TEG, away from a center of the TCD oven.

7. The TCD based GC device as claimed in claim 4, wherein the TEG is electrically operated by an electronic control circuit.

8. The TCD based GC device as claimed in claim 1, wherein the TCD oven comprises a thermal isolation membrane.

9. A Thermal Conductivity Detector (TCD) based Gas Chromatography (GC) device operating under constant temperature, comprising:
a TCD oven formed by a plurality of walls, wherein the TCD oven comprises an inlet valve and an outlet valve;
a heating source mounted on any one of plurality of walls of the TCD oven;
a Thermoelectric Generator (TEG) thermally connected to a TCD element, wherein the TCD element is arranged proximate to the TEG;
at least one temperature Sensor thermally connected to TEG; and
a detector circuit connected to the TCD element.

10. The TCD based GC device as claimed in claim 9, wherein the TCD oven is a cavity arranged to receive at least carrier gas and analyte gas.

11. The TCD based GC device as claimed claim 9, wherein the TCD element is arranged proximate to a first side of the TEG with a predefined distance in between the first side of the TEG and the TCD element, wherein the TCD element is operated by the detector circuit.

12. The TCD based GC device as claimed in claim 9, wherein the TEG is a cooling unit comprising a first side, second side, and an extended conductive path.

13. The TCD based GC device as claimed in claim 12, wherein the first side of the TEG is cooler compared to the second side of the TEG.

14. The TCD based GC device as claimed in claim 12, wherein the extended conductive path is at least one of a conductive path that extends from the second side of the TEG, away from the center of the TCD oven.

15. The TCD based GC device as claimed in claim 9, wherein the TEG is electrically connected to a power supply unit via an electronic control circuit.

16. The TCD based GC device as claimed in claim 9, wherein the at least one temperature sensor is thermally connected to a first side of the TEG.

17. The TCD based GC device as claimed in claim 16, wherein the at least one temperature sensor and an electronic control circuit is cooperatively connected to control the TEG.

18. The TCD based GC device as claimed in claim 9, wherein the TCD oven comprises a thermal isolation membrane to thermally isolate the TEG from the cavity of the TCD oven.
